(19) United States
(12) Patent Application Publication
(10) Pub. No.: US 2014/0024005 A1
(43) Pub. Date: Jan. 23, 2014

(54) Multi-Platform Learning Environment

(71) Applicant: Logical Operations Inc., Rochester, NY (US)

(72) Inventors: Zev Rosenthal, Pittsford, NY (US); Jeffrey Felice, Pittsford, NY (US)

(21) Appl. No.: 13/944,332

(22) Filed: Jul. 17, 2013

Related U.S. Application Data
(60) Provisional application No. 61/673,001, filed on Jul. 18, 2012.

(51) Int. Cl. G09B 5/00

(52) U.S. Cl. CPC G09B 5/00
USPC 434/308; 434/350

(57) ABSTRACT

A multi-platform learning environment is provided. The environment supports instructor/expert-facilitated learning in multiple modalities, tracks learners, and displays content that is relevant to a particular course, learning need and/or platform (e.g., personal computer, mobile device or tablet). The environment includes a learning interface that integrates various training into a single component that supports multiple training modalities. Related apparatus, systems, techniques and articles are also described.

### CROSS-REFERENCE TO RELATED APPLICATION

This application claims the benefit of U.S. Provisional Patent Application No. 61/673,001, filed on Jul. 18, 2012, and entitled “Multi-Platform Learning Environment and Materials for Education,” the content of which is incorporated by reference herein in its entirety.

### TECHNICAL FIELD

The present subject matter relates to systems and methods for supporting learning using a multi-platform learning environment. The subject matter disclosed herein relates more specifically to a customizable and interactive digital multi-platform learning environment that encourages a shared learning experience among learners through traditional and/or virtual classroom experiences using printed (optional) and/or digital learning tools.

### BACKGROUND

Over the last few years new electronic devices like smartphones and tablets, which first found their way into our personal lives, have increasingly been finding their way into our professional and/or work lives as well. These new devices have fueled the start of what promises to be a dramatic shift in the way we are able to communicate and connect with each other and otherwise receive and digest information. Collaboration tools, social networks, online meetings, always-on network connections and the ability to be “connected” 24×7×365 are only a sampling of what's radically changing how we educate ourselves, handle our professional lives and relationships, manage our work responsibilities and/or effectively train our employees.

Training and learning are an important part of professional development. In today's global marketplace, professionals compete with other professionals and businesses compete with other businesses around the world, making it crucial to have yourself and/or your employees equipped with the most up-to-date technical and professional skills. In the competitive working landscape, for example, every organization realizes the need to train its employees to gain a professional edge. As the owner or manager of a business it is important to consider certain factors when making decisions regarding training and educating employees, particularly in businesses where effective training of employees can directly impact profits. These factors include (i) business dynamics (i.e., growing the business through innovation while sustaining it through cost efficiencies and organizational effectiveness), (ii) organizational dynamics (i.e., fewer people doing more work while being expected to lead and jump-start initiation and innovation), (iii) workforce dynamics (i.e., work is increasingly global, mobile, and affected by the adoption of new technologies and approaches rather than age) and (iv) technology and mindset (i.e., moving from alignment to full organizational integration).

In this ever-changing environment, training organizations and private instructors must also deliver training programs that best suit the instructor's instruction preference and/or a student's learning style. In the same respect, acquiring and/or improving upon the skills and knowledge required for becoming more effective on the job is vital for individual business professionals.

One major challenge for businesses, training centers, educational institutions, private instructors, and even individual professionals, is that no two people learn in exactly the same way, have the same schedule and/or can be in the same location. Put simply, what works well for one person may not be effective and/or convenient for another. Therefore, the need exists for a multi-platform learning and training environment that integrates printed (optional) and/or digital learning tools. The multi-platform environment needs to provide businesses, training centers, educational institutions, instructors, business professionals, and students the flexibility to configure a learning environment that focuses on individual skill attainment in a manner of time and/or location that works most effectively for each trainee.

There is a further need to provide learning tools that can be used in traditional instructor-led training (“ILT”) classes, fully-virtual instructor-led training (“V-ILT”) classes or mixed classes with students located both in the classroom with an instructor and located remotely. There is also a need to provide a learning environment that can be easily configured to deliver an asynchronous learning experience using, for example, online learning resources to facilitate information sharing outside the constraints of time and place among a network of people, where such asynchronous or mentored learning is more practical.

### SUMMARY OF THE INVENTION

A system providing a multi-platform learning environment with printed (optional) and/or digital learning tools is disclosed herein. Embodiments of the system support instructor and/or expert-facilitated learning across multiple platforms while using multiple learning modalities, including, learning in a traditional classroom setting involving a group of individuals, learning in a virtual classroom setting involving a group of individuals or learning in a virtual asynchronous setting. System embodiments may also track learners and display content relevant to a particular topic or course and/or learning need. Some embodiments may also display content based on the type of platform (e.g., personal computer, laptop, mobile device, smartphone or tablet) through which the individual is viewing and listening to the material being presented. System embodiments integrate various learning environments and processes into one common platform to support multiple learning modalities.

Some embodiments of the present disclosure may be directed to a learning system that provides one or more learning tools usable across multiple platforms. The learning system may include at least one server and an online learning tool connected to a network and the at least one server to provide a learning interface to one or more users. In some embodiments, the learning interface may present information relating to one or more learning courses for each of the one or more users to participate in. In some embodiments, each of the one or more learning courses may includes a course home page having at least one resource tile linking to one or more content objects and/or one or more external network sites.

Some embodiments of the learning system may include an online learning tool configured to display the learning interface simultaneously on a plurality of different platforms. Some embodiments of the learning system may include an online learning tool configured to enable a first user of the one or more users located at a first location and a second user of the one or more users located at a second location remote to the first location to simultaneously view the same learning interface for the same learning course taught by the same instructor using different platforms. Embodiments of the learning system may include an online learning tool being configurable by the one or more users to customize one or more aspects of the online learning tool. Learning system embodiments may also include a physical classroom having one or more workstations, one or more display screens, and one or more cameras for interacting with one or more virtual classrooms. The virtual classroom in some embodiments may also include one or more workstations, one or more display screens, and one or more cameras for interacting with the physical classroom.

Some embodiments of the online learning tool may include videos for studying the subject matter of a learning course before, during or after class. In some embodiments of the learning system, at least one of the at least one resource link may include one or more links to external Internet sites to allow the one or users to engage in discussions relating to the subject matter of a learning course. In some learning system embodiments, the plurality of different platforms may include a personal computer, laptop, tablet or smartphone. Embodiments of the learning system may include a printed learning tool associated with at least one of the one or more learning courses and for use by the one or more users in conjunction with the online learning tool.

The subject matter of the present disclosure also includes method embodiments for learning across multiple platforms. Some embodiments may include providing an online learning tool connected to a network and at least one server to provide a learning interface to one or more users. The learning interface may include information relating to one or more learning courses for each of the one or more users to participate in. In some embodiments, each of the one or more learning courses may include a course home page having at least one resource tile linking to one or more content objects and/or one or more external network sites.

The subject matter of the present disclosure also includes device embodiments directed to an online learning tool connected to a network and at least one server and which provides a learning interface to one or more users. The online learning tool may include a learning interface having information relating to one or more learning courses for each of the one or more users to participate in. In some embodiments, each of the one or more learning courses may include a course home page having at least one resource tile linking to one or more content objects and/or one or more external network site. In some embodiments, the online learning tool may be configured to enable a first user of the one or more users located at a first location and a second user of the one or more users located at a second location remote to the first location to view the same learning interface for the same learning course taught by the same instructor using different platforms at substantially the same time.

The subject matter of the present disclosure also includes articles of manufacture that are described as comprising, in some embodiments, computer executable instructions that may be permanently stored on non-transitory computer readable media, which, when executed by a computer, cause the computer to perform one or more operations. Some computer system embodiments may include a processor and a memory coupled to the processor. The memory may temporarily or permanently store one or more programs that cause the processor to perform one or more of the operations described herein. In addition, operations specified by methods can be implemented by one or more data processors either within a single computing system or distributed among two or more computing systems.

The subject matter described herein provides many advantages. For example, the systems and methods provide a flexible and efficient learning platform by aggregating and integrating multiple learning modalities into a single platform. The systems and methods also provide a customized and optimized “smart” learner experience by customizing the learner interface to allow the learner access to relevant content.

The details of one or more variations of the subject matter described herein are set forth in the accompanying drawings and the description below. Other features and advantages of the subject matter described herein will be apparent from the description and drawings, and from the claims.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating a multi-platform learning environment in accordance with some embodiments of the present subject matter.

FIG. 2 illustrates a home page or dashboard of a learning tool of a multi-platform learning environment in accordance with some embodiments of the present subject matter.

FIG. 3 illustrates a course page of a learning tool of a multi-platform learning environment in accordance with some embodiments of the present subject matter.

FIG. 4 is an exemplary page of a learning tool of a multi-platform learning environment that contains content related to the material being taught in accordance with some embodiments of the present subject matter.

Like reference symbols in the various drawings indicate like elements.

### DETAILED DESCRIPTION

The subject matter of the present disclosure describes a flexible, multi-platform learning environment for a traditional, virtual, synchronous and/or asynchronous classroom setting that may be available at anytime, anywhere and via any medium or personal electronic device. The multi-platform learning environment disclosed herein allows individuals to view, listen to and/or interact with an instructor and/or educational and/or training materials via one or more platforms in one or more modalities, including without limitation, a traditional synchronous classroom setting involving a group of individuals, a virtual classroom setting involving a group of individuals or a virtual asynchronous setting. Because no two people learn the exact same way, embodiments of the present disclosure provide multi-platform learning systems and methodologies that allow businesses, training centers, educational institutions, instructors, business professionals, students, and others to customize, deliver and/or experience training programs that focus on individual skill attainment to allow participants to learn in the way that they find most effective.

Some individuals, for example, may learn most effectively on their own, i.e., asynchronously, via a virtual environment using a laptop, smartphone, or tablet at their desk, at home, or while traveling. Some individuals may prefer to learn on their own, i.e., asynchronously, and thereafter have a shared learning experience through social media platforms by discussing topics and/or asking questions in a chat room, on Facebook, via Twitter or some other online social media platform. Some individuals may prefer a group setting, either in a traditional classroom or in a remote virtual classroom setting where, for example, an instructor and/or learning materials appear on a common screen or individual laptops accompanied by a corresponding audio transmission of the instructor. Some businesses, in particular, might find that hosting and conducting a virtual or blended classroom experience is most effective for implementing a training initiative or otherwise educating employees.

Embodiments of the multi-platform learning environment disclosed herein also contemplate sustained learning support that extends beyond the confines of a traditional and/or virtual classroom using printed (optional) and/or digital learning tools. Such support may include, without limitation, engaging with social media platforms, preparing and following checklists, taking pre-, during- and/or post-class tests or assessments and/or studying additional course materials, including instructional questions, videos, presentations and other digital or hard-copy materials.

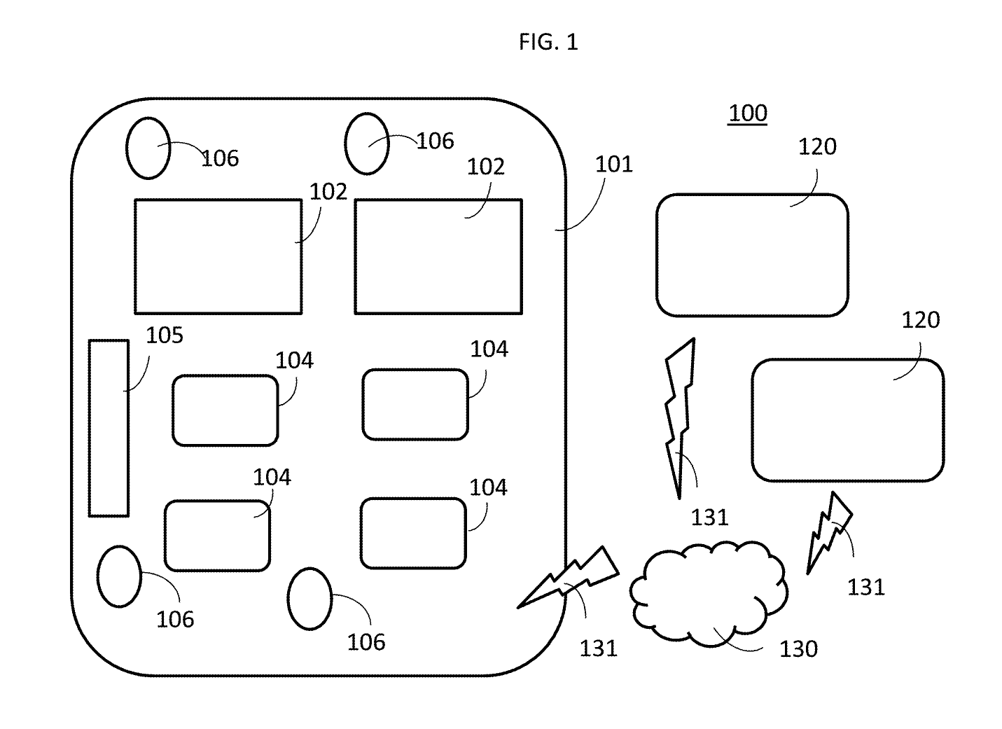

FIG. 1 shows a multi-platform learning environment 100. The environment 100 may generally include one or more servers 130 connected via one or more connections 131 to one or more classrooms 101 and one or more remote access locations 120. The connections 131 may be, for example, wired, wireless (public or private), or some other known network connection method through the Internet, an intranet and/or any other known and acceptable network medium. The one or more classrooms 101 may include one or more workstations 104 for use by one or more learners and/or instructors. The one or more remote access locations 120 may also include one or more workstations (not shown) for use by one or more learners and/or instructors.

The one or more classrooms 101 may be equipped with a variety of technologies that allow remote learners at the one or more remote access locations 120 to fully engage in the learning experience that is occurring in the one or more classrooms 101. For example, as shown in FIG. 1, a classroom 101 may include one or more display screens 102, such as electronic “whiteboards” or “smartboards,” that allow information written thereon to be electronically transmitted (e.g., in real time) to one or more remote access locations 120. The one or more classrooms 101 may include one or more cameras 106 to allow, for example, images, screens of instructor or learner workstations (e.g., desktop, laptop, tablet, or smartphone) and/or classroom activities to be transmitted to the remote access locations 120 and/or recorded. One or more cameras (not shown) may be provided in a similar fashion at the one or more remote access locations 120 to allow images, workstation screens, classroom activities, the classroom itself and/or other items at the one or more remote access locations 120 to be recorded or transmitted to the instructor and/or learners in the one or more classrooms 101. One or more of the cameras 106 may also be used to connect the individuals (teacher(s), coach(es), trainees and/or students) in the classroom 101 or at one or more remote locations 120 with one or more social media communities.

In some embodiments, as shown in FIG. 1, the one or more classrooms 101 may include one or more display devices 105 (e.g., a large projection screen or display) for showing, for example, images, workstation screens (e.g., from one or more workstations in the classroom 101 or at one or more remote access locations 120), classroom activities, the classroom or other items or course materials. The one or more remote access locations 120 may include such display devices as well according to some embodiments. In some embodiments, images, workstation screens (e.g., from one or more workstations in the classroom 101 or at one or more remote access locations 120), classroom activities, the classroom or other items or course materials may be displayed in one or more secondary portions or “windows” within a primary screen on the workstations 104. The one or more display devices 105 may include without limitation personal computers, tablets, mobile computers, smartphones or the like. It should also be noted that each of the one or more workstations 104 (e.g., to be used by the learners, instructors, in the one or more classrooms 101 or at remote access locations 120) may be a computer (e.g., desktop, laptop, tablet, or smartphone) with cameras, microphones and other devices that allow for two-way real-time communication of voice, audio, video and images among the learners and the instructor. In some embodiments, the one or more workstations 104 do not require a two-way real-time communication (for example, a one-way device that receives and displays a real-time or a previous recording).

The one or more remote access locations 120 may include one or more remote learners connected to one or more servers 130 at home, at a remote office or some other location (e.g., traveling in a car, train, plane or bus). The one or more remote learners may also be connected individually or in groups. In some embodiments, the one or more remote learners may be connected via future projection technologies (e.g., 2D or 3D projection technologies) (not shown in FIG. 1). One or more of the remote access locations 120 may also include an instructor or coach (either primary “teachers” and/or supplemental/secondary teaching assistants/coaches) who are connected and participating in the learning experience via a remote connection.

In some embodiments, the teaching, instruction or training may be delivered in real-time whereby the instructors and learners all participate in the learning experience at the same time (also referred to as a “synchronous” mode). The training can also be delivered in an “asynchronous” mode, where the instructors may post and/or review/grade/provide feedback on lessons/activities/tests for learners and the learners may complete these actions on their own (e.g., within either a fixed or limited time). In some embodiments, the training includes a mix of synchronous and asynchronous experiences.

The learning environment depicted in FIG. 1, including all its components, is merely exemplary and for illustration purposes. Various combinations of classrooms, remote access locations, workstations, cameras, display devices and servers are contemplated within the subject matter of the present disclosure.

Embodiments of the multi-platform learning environment may also include digital and/or optional printed learning tools, such as one or more online or otherwise electronic learning interfaces and/or hard-copy courseware (e.g., textbooks on particular subject matter), respectively, to be used within the multi-platform learning environment by instructors and learners alike.

Embodiments of the one or more online learning interfaces may be viewed and interacted with by businesses, training centers and/or individuals (e.g., private instructors, business professionals and/or students) through one or more workstations (e.g., desktop, laptop, tablet, or smartphone) while in the classroom and/or at any of one or more remote access locations (e.g., a remote classroom, at home, at the office or while traveling). In some embodiments, the learning interface may include links (e.g., tiles, graphics or text links) within one or more digital pages (e.g., html-based, xml-based) and may be accessible over one or more networks (e.g., the Internet, an intranet or the like) by learners from any location having an appropriate network connection. For example, the learning interface may be a website accessible by learners through the Internet by typing into an Internet browser an appropriate uniform resource locator, or “URL.”

Embodiments of the learning interface may include a login page where an individual (e.g., a business, a training center or solo professional) may enter a username and password to gain access into the learning interface. In some embodiments a first-time user may be given an access key and asked to enter such key to be directed to an enrollment page within the learning interface for entering certain personal information and setting up an account or profile.

Embodiments of the learning interface may include a home page, or “dashboard,” that displays one or more icons, tiles or hypertext links, including, without limitation, a “Home” icon, “Search” icon, “Log Out” icon and/or “My Account” icon, along with an “Add A Course” tile and/or one or more tiles of specific courses (e.g., “Microsoft Office PowerPoint 2010: Part I”) on specific topics or subject matter to be learned.

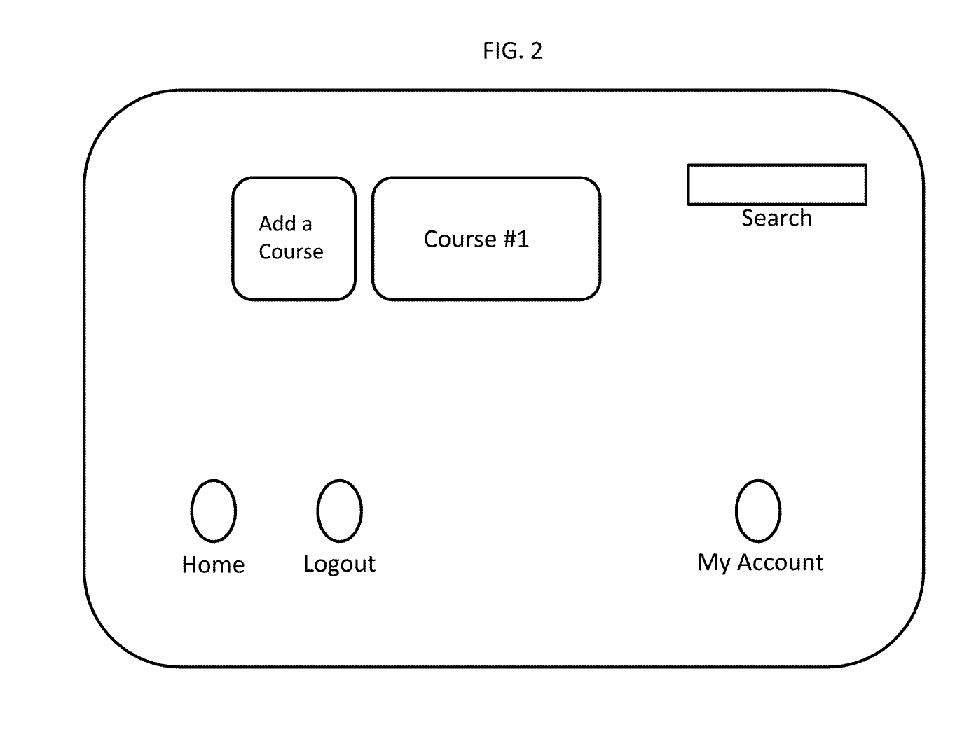

Selecting the “Add A Course” tile allows a learner to add one or more courses that he/she has already purchased (or which have been purchased for or assigned to him/her) and which are associated with his/her learning interface account. In some embodiments, adding a course may involve inputting an access key. For example, an employee at company X may be in need of training in Microsoft Excel and Microsoft Word, in which the employer may purchase and assign to the employee's learning interface account one or more courses on Microsoft Excel and Microsoft Word for the employee to take and learn from. Some embodiments, for example those for use by businesses or training centers, may also include an “Admin” icon for accessing a backend portion of the learning interface and configuring the learning program to be customized to meet specific needs of specific learners, as discussed in more detail below. In some embodiments the “Search” icon may include a search field, as shown in FIG. 2, that may be used to search for various materials or subject matter within the learning interface, including one or more courses that have been assigned to a learner.

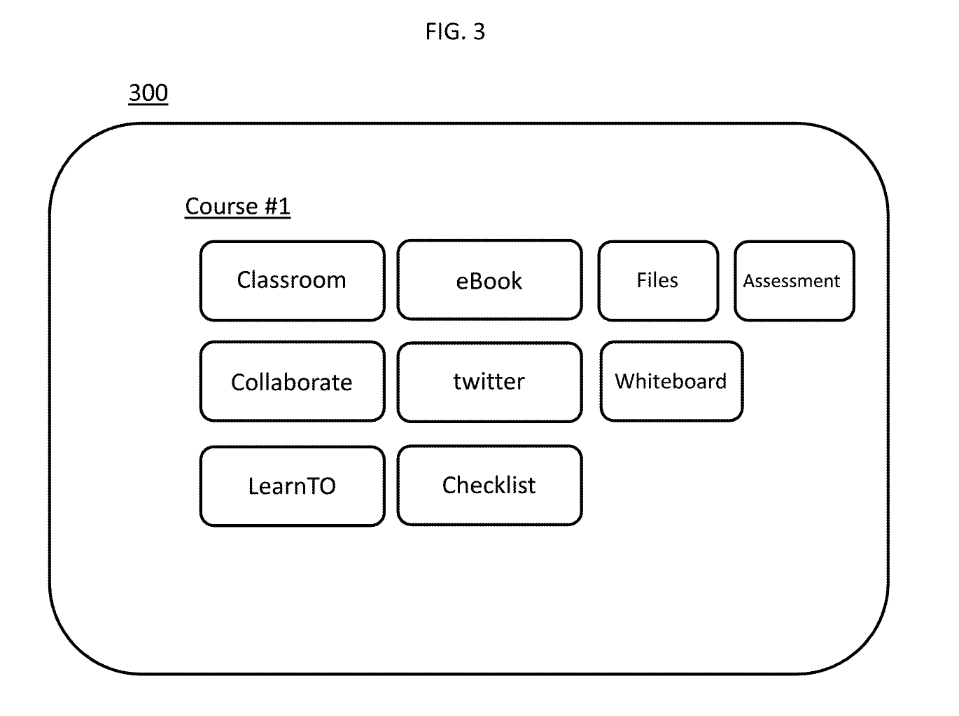

FIG. 3 shows an exemplary course home page 300 of a learning interface embodiment according to the present disclosure. The depicted course home page 300 may be displayed upon selecting (e.g., clicking on) the course tile on the main home page of the learning interface that corresponds with that particular course (e.g., a course tile entitled “Microsoft Office PowerPoint 2010: Part I”). A course home page may display one or more resource tiles, as shown in FIG. 3, that according to some embodiments may link to one or more content objects stored on one or more servers or data storage locations associated with the learning interface or may link to one or more external websites (e.g., social media communities, such as Facebook, Twitter or LinkedIn). The one or more resource tiles of a course home page may include, without limitation, eBook versions of training materials, checklists, quizzes/examinations, reading lists, external links to programs/information pertaining to the subject matter being taught, remote labs or simulations, social network communities of similar students (e.g., Facebook), Twitter feeds, websites, online reference materials/manuals, self-paced “e-learning” modules that reinforce concepts taught in the classroom and/or extend the classroom learning to cover material not taught during the formal class, notes, online stores for purchasing training materials, newsletters, announcements, and/or a “my account/settings” function. When a learner (e.g., an employee, solo professional or student) clicks on a tile, the learning interface may display, in some embodiments, the appropriate material or a sub-menu to the learner.

The embodiment depicted in FIG. 3 relating to “Course #1” specifically depicts a “Classroom” tile, “Collaborate” tile, “LearnTO” tile, “eBook” tile, “Twitter” tile, “Checklist” tile, “Files” tile, “Assessment” tile and “Whiteboard” tile. According to some embodiments, selecting the “Classroom” tile may provide access to classroom sessions that are currently taking place or that have already occurred. In some embodiments selection of the “Classroom” tile may cause a pop-up window to appear in which a URL may be inserted to log into a virtual classroom session. The “Classroom” tile may be used by businesses, training centers and/or private instructors for hosting and conducting a virtual or blended (traditional and virtual) classroom experience, wherein remote learners can view the classroom by logging into the session through the “Classroom” tile from any location and using any particular platform (e.g., a personal computer, tablet, laptop or smartphone).

According to some embodiments, selecting the “Collaborate” tile on a course home page may provide a learner with a direct link to one or more social media platforms, wikis, blogs, message boards, discussion forums or other external websites for learners to leverage inside or outside the classroom and create an avenue of collaborative thinking and discussion beyond the realm of the classroom instruction. The specific URL to which a learner may be taken after selecting the “Collaborate” tile may be configured by the administrator of the business, training center, or academic institution.

Some embodiments of the course home page may also include a “LearnTO” tile, as shown in FIG. 3, which may provide a learner with short (e.g., 3-9 minutes) video tutorials relating to topics or subject matter for courses assigned to the learner. The LearnTO videos may be used for reinforcing and expanding on key concepts within the text, as an instructional aid within the classroom and/or as pre- or post-class reference material. The short videos (i.e., “knowledge bursts”) can be utilized by instructors and/or learners alike. Some embodiments relate to instructors (e.g., on behalf of a business or training center) using one or more videos as an impactful learning aid in a traditional and/or virtual class. Other embodiments relate to learners using the LearnTO videos as a tool for independent pre- or post-class training support. For example, following a virtual classroom session on Microsoft PowerPoint, a learner may select the LearnTO (e.g., on the way home from work) to view and study one or more videos regarding Microsoft PowerPoint and, in particular, the subject matter that was just covered in the classroom session.

Some embodiments of the course home page may also include an “eBook” tile, the selection of which may provide a learner with links to digital or electronic copies of printable (e.g., hard-copy versions) of courseware that can be viewed by the learner on the screen of his/her workstation and/or printed as a hard-copy version. The courseware accessible via the “eBook” tile may also be downloaded to memory on a workstation or one or more servers. For example, with reference to FIG. 3, the “eBook” tile may provide a link to one or more portable document format (PDF) course books for Course #1. The eBook may also include one or more links to classroom notes provided by the instructor or other learners (in class or located remotely), as well as to supplemental reference materials for additional reading and learning.

In some embodiments, the course home page may include a tile that provides a direct link to an external website, such as a social media site for further discussion on the topics being learned. For example, FIG. 3 depicts a Twitter tile, through which the learner may access Twitter to talk about their learning experiences and learn from the experiences of others.

Some embodiments of the course home page may also include a “Checklist” tile that may provide a learner with quick access to reference materials configured in an easy-to-use format. For example, with respect to the Course #1 example shown in FIG. 3, selecting the “Checklist” tile may provide another screen having one or more links to quick overviews or bullet point lists of the more detailed information covered in a classroom session, which can be used as job aids after class as a reference to performing skills back on the job.

The course home page in some embodiments may also include a “Files” tile, as depicted in FIG. 3, which contains course files that the user has downloaded for each of the courses in which he is signed up for and/or participating/participated in.

Embodiments of the learning interface also include course home pages having an “Assessment” tile, as shown in FIG. 3. By selecting this tile, a learner may be provided a timed, or untimed, series of questions that evaluate what the learner has learned in a course that he/she is participating in or has participated in to identify competency gaps and validate comprehension. The “Assessment” tile can be used by instructors, in some embodiments, as a pre- or post-class evaluation tool and/or by learners to gauge training return on investment through post-class training.

Embodiment of the course home page may also include a “Whiteboard” tile, as shown in FIG. 3, which may be a customizable component of the learning interface for enhancing the learning experience by allowing instructors/teachers to share notes and explanations with learners situated in the classroom (e.g., traditional and/or virtual via cameras 106), interact seamlessly with students in one or more remote access locations and also encourage class participation.

Depending on the embodiment, additional tiles that may be provided on the course home page, including without limitation, a “Notice” tile (provides notices from one or more administrators of the learning program), a “Virtual Labs” tile (provides remote access to technical environments for a course), a “Field Trips” tile (directs students to destinations outside of the classroom), an “AutoMailer” tile (provides the option to sign-up for a newsletter or blast on course-related information), a “Notes” tile (provides additional information, guidance or hints about a topic or task) a “Newsletter”/“Announcement” tile (provides newsletters or other communications from a training provider), a “Sonic” tile (provides videos to be purchased by learners for use inside or outside the classroom), a “My Mentor” tile (provides connections to a threaded message board and/or a website to post questions to be answered by an instructor or expert), a “My Learning Center,” or “LC” tile (provides a link to an external training center website or internal training pages), and/or a “Store” tile (provides links to purchases courses and other items for use with the learning program and the multi-platform learning environment, e.g., print-versions of course books).

The system according to the present subject matter may be configured to expose and/or hide different tiles depending on various factors. For example, in a live classroom, the system may expose the “Whiteboard” tile but hide that tile when accessed remotely at a later date/time by the student. In some embodiments, the system has the ability to hide/unhide tiles based off of the date. Similarly, the “Checklist” tile might not be needed while in the live training event (i.e., in the classroom) and can be hidden in the classroom. Once the live training event is over (e.g., at the end of the class), the system may be configured according to some embodiments to expose the “Checklist” to the learner. The system may also determine which tiles to display depending on the type of workstation being used. For example, if the workstation is, for example, a smartphone, which may not be suitable for reading long passages, the “eBook” option may be hidden (e.g., not shown/made available) and only display options, such as “Checklist” or a “LearnTO.”

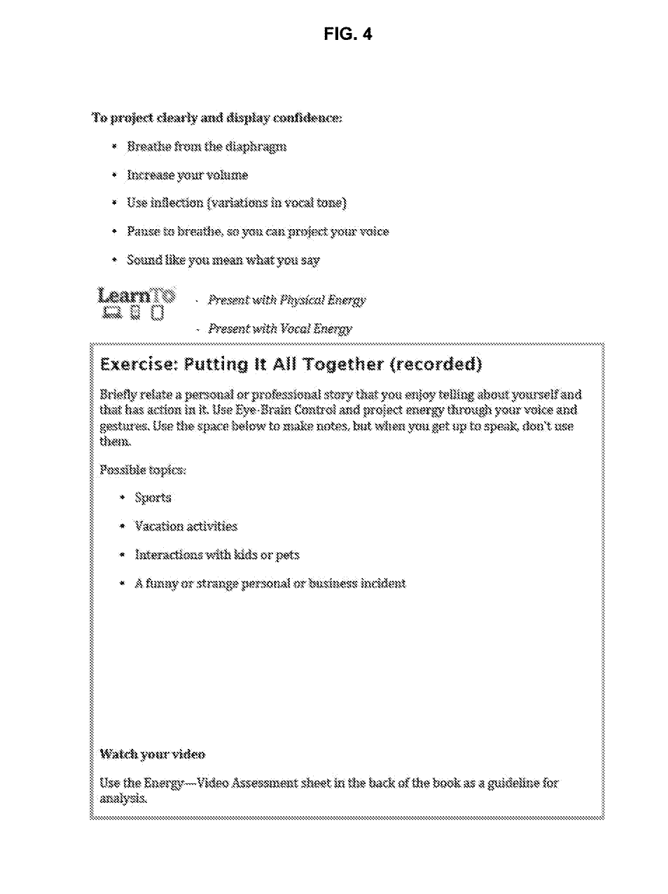

Written, printed or otherwise hard-copy documentation (i.e., “courseware”), such as a textbook on particular subject matter, that tracks what's being done online or virtually may also be provided to both the learners and the instructors. FIG. 4 shows an exemplary page of a courseware book (which can be either hardcopy or in electronic format) that contains content related to the material being taught. The courseware may include written descriptions of concepts, procedures and the like and, in electronic form, may also include tiles that represent links to electronic reference materials (such as e-learning components and/or external website links), asynchronous classroom events, expert support, figures, illustrations, diagrams, photos, and the like. In the electronic form (“eBook”), written sections may be hyperlinked to online content and/or figures, illustrations, diagrams, photos, and the like, and may also link to videos and/or other multimedia content.

The multi-platform learning environment described above, including for example the system described above with reference to the FIG. 1 and the learning tools described above with reference to the FIGS. 2-4 provide a flexible multi-platform learning environment and methodology that can be utilized to create and deliver a learning experience that can be delivered and received in person and/or remotely, synchronously and/or asynchronously anytime, anywhere and via any platform.

Some embodiments of the present disclosure may also be configured to allow businesses, training centers, private instructors and even individual business professionals with the ability to customize one or more aspects of the learning environment. For example, in some embodiments, businesses, training centers, private instructors, and/or individual business professionals may be able to act as the administrator of the online learning interface and configure what courses are to be assigned to one or more learners, the text, size, shape, color, graphics and layout/arrangement of the tiles in each learner's course home pages and/or main home page (dashboard), as well as dictate what content objects (e.g., videos, eBooks) are contained within certain tiles (e.g., the “LearnTO” tile, “eBook” tile, “Checklist” tile or “Assessment” tile) and what internal or external site(s) one or more tiles (e.g., the “Collaborate” tile) may link to. Additional functions that administrators may have include, without limitation, enabling/disabling tiles, previewing changes using preview screen, adding a dialog box, saving final configurations, resetting the interface to a previous configuration and/or creating and providing access keys to learners.

In some embodiments, administrators may apply their custom configurations to a Base Instance or a Special Client Instance for a particular course or particular learner. The Base Instance may be a standard/default instance and configuration that would be deployed to a majority of learners, businesses or training centers. The Client Instance in some embodiments may be a special or custom instance of a course that would be deployed for a particular learner, business or training center, or group of learners, businesses or training centers. The Client Instance may have different content, or destination URLs (such as a special group created for that class on LinkedIn) set for that particular training event. Some embodiments of the Client Instance courses may also have a “Time Aware” mode, wherein the Administrator may choose which tiles to expose to learners on particular dates, controlling what content learners see before, during and after class.

Aspects of the subject matter described herein can be embodied in systems, apparatus, methods, and/or articles depending on the desired configuration. In particular, various embodiments of the subject matter described herein can be realized in digital electronic circuitry, integrated circuitry, specially designed application specific integrated circuits (ASICs), computer hardware, firmware, software and/or combinations thereof. These various embodiments can include implementation into one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as, for example, as would a processor cache or other random access memory associated with one or more physical processor cores.

To provide for interaction with a learner, the subject matter described herein can be implemented on a computer having a display device, such as, for example, a cathode ray tube (CRT) or a liquid crystal display (LCD) monitor for displaying information to the learner and a keyboard and a pointing device, such as, for example, a mouse or a trackball, by which the learner may provide input to the computer. Other kinds of devices can be used to provide for interaction with a learner as well. For example, feedback provided to the learner can be any form of sensory feedback, such as, for example, visual feedback, auditory feedback, or tactile feedback; and input from the learner may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical learner interface or a Web browser through which a learner can interact with embodiments of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The embodiments set forth in the foregoing description do not represent all embodiments consistent with the subject matter described herein. Instead, they are merely some examples consistent with aspects related to the described subject matter. Although, a few variations have been described in detail herein, other modifications or additions are possible. In particular, further features and/or variations can be provided in addition to those set forth herein. For example, the embodiments described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other embodiments.

What is claimed is:

1. A learning system for providing one or more learning tools usable across multiple platforms, the system comprising:
at least one server; and
an online learning tool connected to a network and the at least one server to provide a learning interface to one or more users, the learning interface including information relating to one or more learning courses for each of the one or more users to participate in,
wherein each of the one or more learning courses includes a course home page including at least one resource tile linking to one or more content objects and/or one or more external network sites.

2. The learning system of claim 1, wherein the online learning tool is configured to display the learning interface simultaneously on a plurality of different platforms.

3. The learning system of claim 1, wherein the online learning tool is configured to enable a first user of the one or more users located at a first location and a second user of the one or more users located at a second location remote to the first location to simultaneously view the same learning interface for the same learning course taught by the same instructor using different platforms.

4. The learning system of claim 1, the online learning tool being configurable by the one or more users to customize one or more aspects of the online learning tool.

5. The learning system of claim 1, the system further comprising a physical classroom having one or more workstations, one or more display screens, and one or more cameras for interacting with one or more virtual classrooms.

6. The learning system of claim 5, wherein the virtual classroom includes one or more workstations, one or more display screens, and one or more cameras for interacting with the physical classroom.

7. The learning system of claim 1, wherein the online learning tool includes videos for studying the subject matter of a learning course before, during or after class.

8. The learning system of claim 1, wherein at least one of the at least one resource link includes one or more links to external Internet sites to allow the one or users to engage in discussions relating to the subject matter of a learning course.

9. The learning system of claim 2, wherein the plurality of different platforms include a personal computer, laptop, tablet or smartphone.

10. The learning system of claim 1, the system further comprising a printed learning tool associated with at least one of the one or more learning courses and for use by the one or more users in conjunction with the online learning tool.

11. A method for learning across multiple platforms, the method comprising:
providing an online learning tool connected to a network and at least one server to provide a learning interface to one or more users, the learning interface including information relating to one or more learning courses for each of the one or more users to participate in,
wherein each of the one or more learning courses includes a course home page including at least one resource tile linking to one or more content objects and/or one or more external network sites.

12. The method of claim 11, wherein the online learning tool is configured to display the learning interface simultaneously on a plurality of different platforms.

13. The method of claim 11, wherein the online learning tool is configured to enable a first user of the one or more users located at a first location and a second user of the one or more users located at a second location remote to the first location to simultaneously view the same learning interface for the same learning course taught by the same instructor using different platforms.

14. The method of claim 11, the online learning tool being configurable by the one or more users to customize one or more aspects of the online learning tool.

15. The method of claim 11, the method further comprising a physical classroom having one or more workstations, one or more display screens and one or more cameras for interacting with one or more virtual classrooms.

16. The method of claim 15, wherein the virtual classroom includes one or more workstations, one or more display screens and one or more cameras for interacting with the physical classroom.

17. The method of claim 11, wherein the online learning tool includes videos for studying the subject matter of a learning course before, during or after class.

18. The method of claim 11, wherein at least one of the at resource link includes one or more links to external Internet sites to allow the one or more users to engage in discussions relating to the subject matter of a learning course.

19. The method of claim 11, wherein the online learning tool includes an interface for allowing one or more users to access a physical classroom session from a remote location using one of a personal computer, laptop, tablet or smartphone.

20. An online learning tool connected to a network and at least one server to provide a learning interface to one or more users, the learning interface including information relating to one or more learning courses for each of the one or more users to participate in,
wherein each of the one or more learning courses includes a course home page including at least one resource tile linking to one or more content objects and/or one or more external network site; and
wherein the online learning tool is configured to enable a first user of the one or more users located at a first location and a second user of the one or more users located at a second location remote to the first location to view the same learning interface for the same learning course taught by the same instructor using different platforms at substantially the same time.
